(19) United States
(12) Patent Application Publication
(10) Pub. No.: US 2014/0375141 A1
(43) Pub. Date: Dec. 25, 2014

(54) KEY SWITCH DEVICE AND KEYBOARD

(71) Applicant: FUJITSU COMPONENT LIMITED, Tokyo (JP)

(72) Inventor: Takashi NAKAJIMA, Tokyo (JP)

(73) Assignee: FUJITSU COMPONENT LIMITED, Tokyo (JP)

(21) Appl. No.: 14/258,293

(22) Filed: Apr. 22, 2014

(30) Foreign Application Priority Data
Jun. 19, 2013 (JP) 2013-128886

(51) Int. Cl. H01H 13/70

(52) U.S. Cl. CPC H01H 13/70
USPC 307/112

(57) ABSTRACT

A key switch device includes a key top, a switch having a first contact and a second contact and in which a contact state between the first contact and the second contact changes in accordance with a movement distance of the pressed key top, and a control device configured to acquire a signal indicative of the contact state between the first contact and the second contact to determine whether or not the switch is in the on state by comparing a contact state value corresponding to the acquired signal and a threshold value that is arbitrarily set, and to transmit an on signal when determining that the switch is in the on state.

### CROSS-REFERENCE TO RELATED APPLICATION

This application is based upon and claims the benefit of priority of the prior Japanese Patent Application No. 2013-128886, filed on Jun. 19, 2013, the entire contents of which are incorporated herein by reference.

### FIELD

The present invention relates to a key switch device and a keyboard.

### BACKGROUND

A keyboard is mounted on an electronic device, such as a desktop or notebook personal computer, a register used in a commercial facility, etc. The keyboard includes key switch devices operated by attaching the key top thereof. The key switch devices have a support plate, a key top arranged on the support plate, and a switch. The switch is for opening and closing a contact of an electric circuit in accordance with the vertical motion of the key top, and a membrane switch or a membrane sheet may be used.

There are known various kinds of techniques to improve the feeling of typing when operating the key switch device, which is determined by the press-down load when the key switch device is pressed down, the displacement of the key top by pressing down the key top until the key switch device turns on, etc.

Patent Document 1: JP-H5-11914

Patent Document 2: JP-H11-282605

### SUMMARY

In one embodiment, the key switch device has a key top, a switch member, and a control device. The switch member has a first contact and a second contact and the contact state between the first contact and the second contact changes in accordance with the distance traveled by the key top when pressed down. The control device acquires a contact state signal indicative of the contact state between the first contact part and the second contact part. The control device compares a contact state value corresponding to the contact state signal and a threshold value and determines whether or not the switch member is in the on state, and transmits an on signal when determining that the switch member is in the on state. It is possible to set the threshold value to any value.

### BRIEF DESCRIPTION OF DRAWINGS

These and other features and advantages of the present invention will be better understood by reading the following description of embodiments, taken together with the drawings wherein:

FIG. 1 is a perspective view illustrating an electronic device;

FIG. 2 is an exploded perspective view illustrating the electronic device illustrated in FIG. 1;

FIG. 3 is an exploded perspective view of a keyboard;

FIG. 4 is an exploded perspective view illustrating a key switch device;

FIG. 5A is a graph showing a relationship between the press-down load and the displacement of a rubber dome;

FIG. 5B is a graph showing a relationship between the press-down load and the displacement of the rubber dome in another example;

FIG. 6 is a section view of a key switch device;

FIG. 7 is a graph showing a relationship between a press-down load, a contact voltage and the displacement of a key top;

FIG. 8 is a circuit block diagram of an example of a personal computer;

FIG. 9 is a block diagram of functions of the calculation unit of key board of the computer illustrated in FIG. 8;

FIG. 10 is a graph showing a relationship between the threshold voltage and the displacement of a key top;

FIG. 11A is a flowchart illustrating determination processing of the calculation unit illustrated in FIG. 9;

FIG. 11B is a flowchart illustrating threshold value setting processing of the calculation unit illustrated in FIG. 9;

FIG. 12 is a circuit block diagram of another example of a personal computer;

FIG. 13 is an equivalent circuit of the computer illustrated in FIG. 12;

FIG. 14 is a block diagram of the functions of the second calculation unit of key board of the computer illustrated in FIG. 12;

FIG. 15 is a graph showing an example of a relationship between the threshold resistance value and the operation load;

FIG. 16A is a flowchart illustrating determination processing of the calculation unit illustrated in FIG. 14;

FIG. 16B is a flowchart illustrating threshold value setting processing of the calculation unit illustrated in FIG. 14; and

FIG. 17 is a graph showing a relationship between the press-down load of the key switch device.

### DESCRIPTION OF EMBODIMENTS

Hereinafter, with reference to the drawings, the key switch device and the keyboard according to the present invention are explained. However, it should be noted that the technical scope of the present invention is not limited to embodiments of those, and equivalents to the inventions described in the claims are also included.

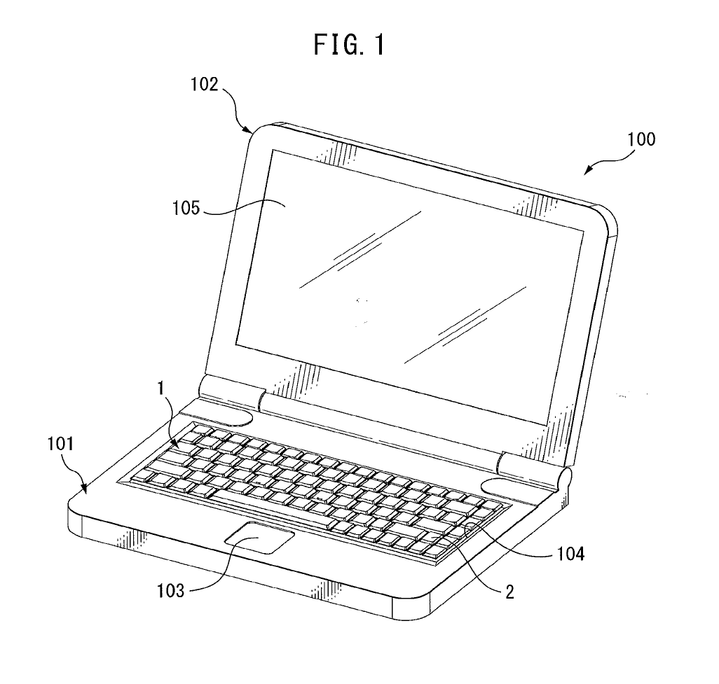

FIG. 1 is a perspective view illustrating an external appearance of a notebook personal computer 100, which is an example of an electronic device.

The personal computer 100 includes a main body 101 and a display case 102 rotatably connected to the main body 101. On the surface of the main body 101, input devices such as a keyboard 1 and a pointing device 103 are incorporated. The keyboard 1 is inserted into an opening 104 formed on the surface of the main body 101. The keyboard 1 includes key switch devices 2 arranged in an array on the single plane.

In the display case 102, an LCD (Liquid Crystal Display) panel module 105 is incorporated. By closing the display case 102 toward the main body 101 so as to overlap the main body 101, the personal computer 100 is folded.

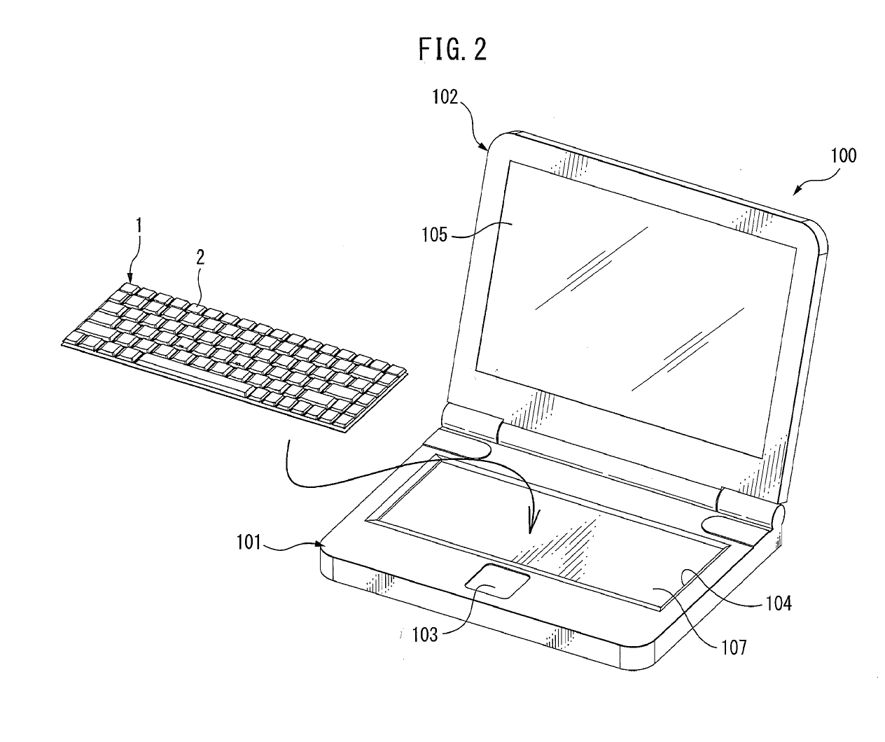

FIG. 2 is an exploded perspective view illustrating a state where the keyboard 1 is removed from the main body 101 of the personal computer 100.

The keyboard 1 is fixed on a support plate 107 arranged within the opening 104 of the main body 101. The surface of the support plate 107 is flat, and the flatness of the keyboard 1 can be maintained. The support plate 107 is formed by a metal such as stainless steel, or a synthetic resin material, or the like. The keyboard 1 is fixed to the main body by screws not illustrated. The screw is screwed into the support plate 107 via a through hole formed in the keyboard 1.

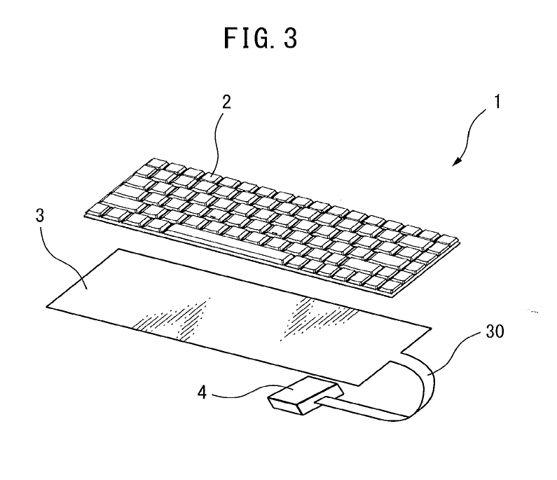

FIG. 3 is an exploded perspective view of the keyboard 1.

The keyboard 1 has a membrane sheet 3 arranged under the key switch devices 2 and a control device 4 connected to the membrane sheet 3 via a tail 30 of the membrane sheet 3.

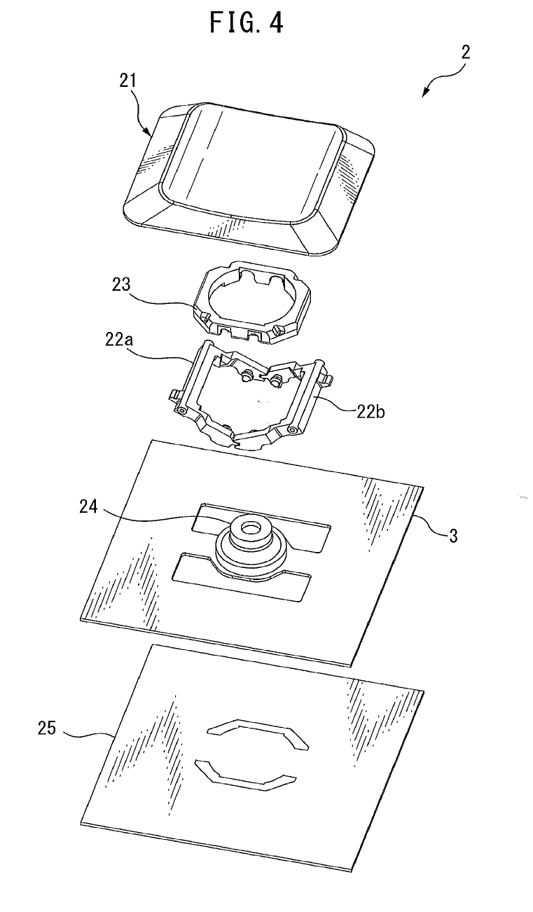

FIG. 4 is an exploded perspective view illustrating the structure of the key switch device 2.

The key switch device 2 has a key top 21, a pair of link members 22a and 22b, a housing 23, a rubber dome 24, the membrane sheet 3 that functions as a switch, and a sheet 25.

The key top 21 is a dish-shaped member having the shape of a square in a planar view and formed by integrally molding a synthetic resin material, such as acrylonitrile butadiene styrene (ABS). The pair of link members 22a and 22b are formed by integrally molding a synthetic resin material, such as ABS, and support the key top 21 so as to be capable of moving vertically. The housing 23 is formed by integrally molding a synthetic resin material, such as ABS, and accommodates the rubber dome 24 inside thereof.

The rubber dome 24 is formed by a flexible synthetic resin, such as silicone resin, and is for pressing down the contact of the membrane sheet 3 in accordance with the pressed-down key top 21. When the key top is pressed down and a press-down load is applied from above, the rubber dome 24 deforms elastically and an elastic restoring force is accumulated. When the key top 21 is released from the pressed-down state, the rubber dome 24 returns to the original shape by the elastic restoring force and the key top 21 returns to the initial position.

The sheet 25 is a thin film formed by a resin material, such as polyethylene terephthalate (PET), polycarbonate (PC), and polypropylene (PP).

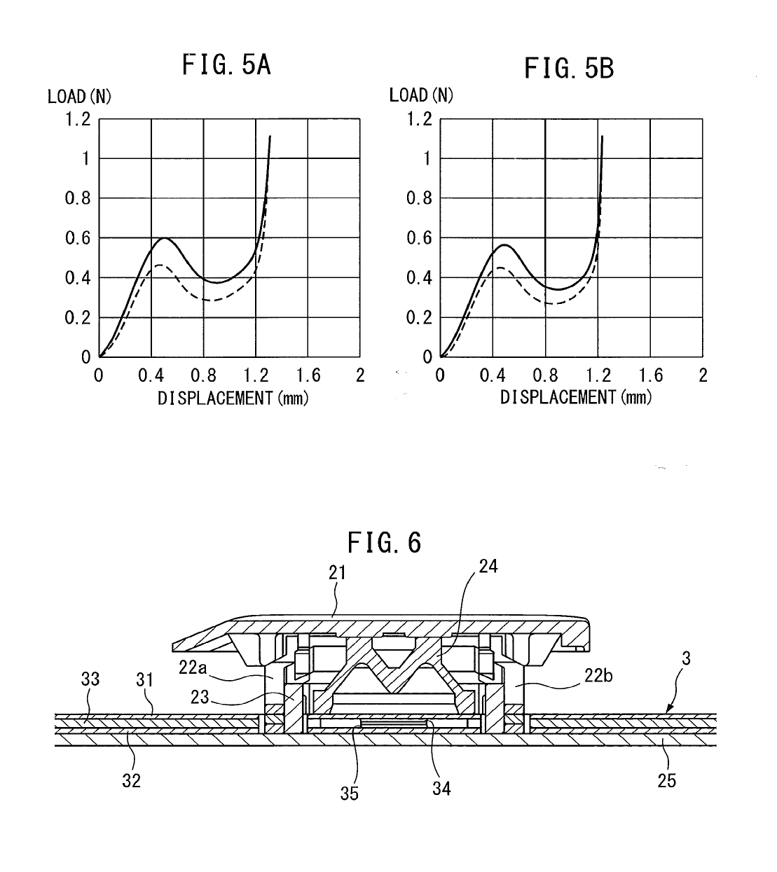

FIG. 5A is a graph showing a relationship between the press-down load and the displacement of the rubber dome of the first example, and FIG. 5B is a graph showing a relationship between the press-down load and the displacement of the rubber dome of another example. In FIGS. 5A and 5B, the horizontal axis represents the displacement of the key top in the vertical direction that presses down the rubber dome, and the vertical axis represents the load to press down the rubber dome. Further, in FIGS. 5A and 5B, the solid line indicates the relationship between the press-down load and the displacement of the rubber dome when the displacement of the key top increases, and the broken line indicates the relationship between the press-down load and the displacement of the rubber dome when the displacement of the key top decreases.

The press-down load of the rubber dome illustrated in FIG. 5A is heavier than the press-down load of the rubber dome illustrated in FIG. 5B. As illustrated in FIG. 5A and FIG. 5B, as the press-down load of the rubber dome used in the key switch changes, the press-down characteristics of the key switch also change. From a comparison between FIG. 5A and FIG. 5B, it is possible to turn on the key switch with a lighter load in the case of the rubber dome in FIG. 5B, than that in the case of the rubber dome in FIG. 5A, and therefore it is possible to operate the key switch with a lighter press-down load. On the other hand, when it is desired to turn on the key switch with a heavier press-down load, it is preferable to use the rubber dome whose press-down load is heavier. The relationship between the press-down load and the displacement of the rubber dome has the hysteresis characteristics and the load when pressing down the rubber dome is heavier than the load when the rubber dome returns.

FIG. 6 is a section view of the key switch device 2.

The membrane sheet 3 has an upper sheet 31, a lower sheet 32, a spacer 32, a first contact 34 and a second contact 35.

The upper side sheet 31, the lower side sheet 32, and the spacer 33 are each a thin film formed by a resin material, such as a polyester film. In the spacer 33, a through hole is formed in a position corresponding to the position where the first contact 34 and the second contact 35 are arranged.

The first contact 34 is formed by electrically conductive ink, such as silver paste and carbon paste, and printed on the backside of the upper sheet 31 together with a wiring pattern. The second contact 35 is formed by electrically conductive ink, such as silver paste and carbon paste, and printed on the top surface of the lower sheet 32 together with a wiring pattern. The first contact 34 and the second contact 35 are arranged so as to oppose each other, via the through hole of the spacer 33. When the key top 21 is not pressed down, the first contact 34 and the second contact 35 are not in contact with each other and the first contact 34 and the second contact 35 are insulated from each other. When the key top is pressed down, the first contact 34 is pressed down by the rubber dome 24, and the first contact 34 and the second contact 35 come into contact with each other. The first contact 34 deforms in accordance with the deformation of the rubber dome 24 when the key top is pressed down, and therefore an area that the first contact 34 and the second contact 35 contact each other (“contact area”) increases gradually. As the contact area increases, the resistance value of the contact resistance between the first contact 34 and the second contact 35 decreases.

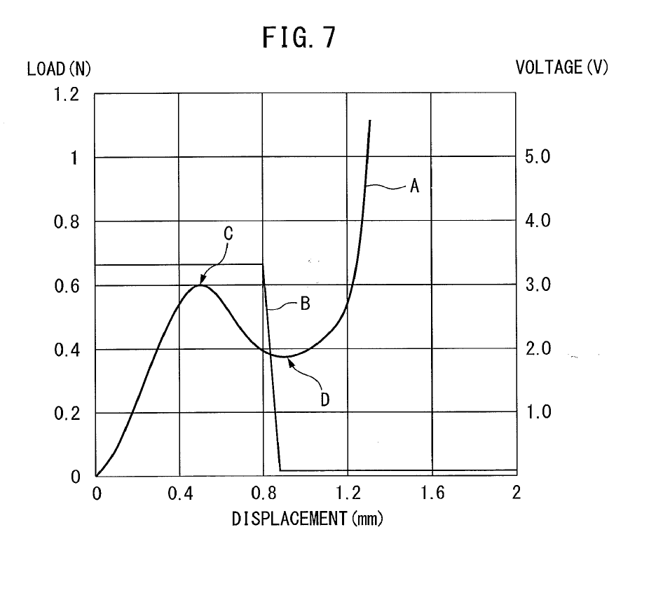

FIG. 7 is a graph showing an example of a relationship among the displacement of the key top 21 in the vertical direction, the press-down load when the key switch device 2 is pressed down, and the voltage between the first contact 34 and the second contact 35 (“contact voltage”). In FIG. 7, the horizontal axis represents the displacement of the key top 21, the vertical axis on the left side represents the press-down load, and the vertical axis on the right side represents the contact voltage. The graph indicated by A shows a relationship between the displacement of the key top 21 and the press-down load when the key switch device 2 is pressed down. The graph indicated by B shows a relationship between the displacement of the key top 21 and the contact voltage between the first contact 34 and the second contact 35.

Until the press-down load reaches a first peak indicated by an arrow C, the press-down load increases as the displacement of the key top 21 increases. After the press-down load reaches the first peak indicated by the arrow C, the press-down load decreases, since the sidewall of the rubber dome curves and the resisting force of the rubber dome decreases. Then, in the vicinity of a second peak indicated by an arrow D in FIG. 7, the top of the rubber dome 24 comes into contact with the membrane 3.

When the top of the rubber dome 24 comes into contact with the membrane sheet 3, and the displacement in the vertical direction of the key top 21 becomes about 0.8 mm as the upper sheet 31 of the membrane sheet 3 is pressed down, the first contact 34 arranged on the backside of the upper sheet 31 and the second contact 35 arranged on the surface of the lower sheet 32 comes into contact with each other. When the first contact 34 and the second contact 35 come into contact with each other, the resistance value of the contact resistance between the first contact 34 and the second contact 35 decreases and the contact voltage between the first contact 34 and the second contact 35 begins to drop. If the key top 21 is further moved in the vertical direction, as the contact area increases gradually, the resistance value of the contact resistance between the first contact 34 and the second contact 35 decreases gradually. As the resistance value decreases, the contact voltage drops. Then, when the first contact 34 and the second contact 35 come into sufficient contact with each other, the resistance value of the contact resistance between the first contact 34 and the second contact 35 becomes sufficiently small, and the contact voltage between the first contact 34 and the second contact 35 becomes substantially zero.

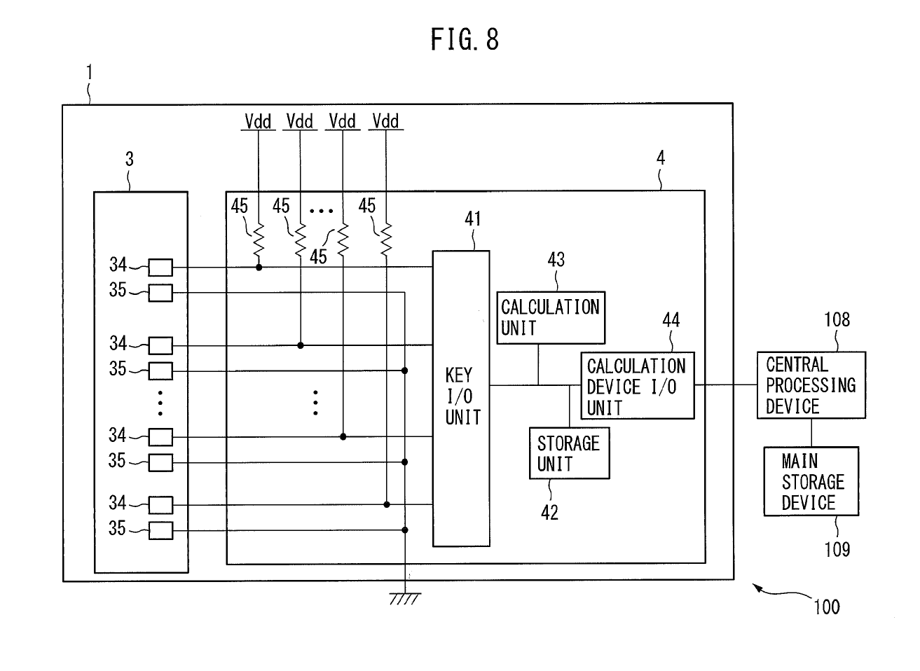

FIG. 8 is a circuit block diagram of a personal computer.

The keyboard 1 has first contacts 34 and second contacts 35 arranged on the membrane sheet 3 and the control device 4 electrically connected to the first contacts 34 and second contacts 35, respectively. The control device 4 is electrically connected to a processing device 108 arranged in the personal computer 100

The control device 4 has a key I/O unit 41, a storage unit 42, a calculation unit 43, a calculation device I/O unit 44, and resistors 45.

Each of the first contacts 34 and second contacts 35 is arranged so as to correspond to the position of the key switch device 2 arranged on the keyboard 1. Each of the first contacts 34 is connected to the key I/O unit 41 of the control device 4 and is connected to a power source via the resistor 45. The second contacts 35 are grounded together.

A voltage signal having a value corresponding to the contact voltage between the first contact 34 and the second contact 35 is transmitted to the key I/O unit 41 from the switch. The key I/O unit 41 converts the contact voltage corresponding to the received contact voltage signal into digital value and outputs the converted contact voltage together with the key switch number indicating the number of the key switch device 2 corresponding to the first contact 34 and the second contact 35 having output the voltage signal.

Computer programs for the processing performed by the calculation unit and information for operating the keyboard 1 are stored in the storage unit 42. The storage unit 42 stores a threshold voltage for determining whether the key switch 2 is in the on state for each key switch 2. The threshold voltage is stored in association with the key switch number of each key switch device 2.

The calculation unit 43 performs processing in accordance with the voltage signal received via the key I/O unit 41 based on the computer programs stored in the storage unit 42.

The calculation device I/O unit 44 outputs a signal output from the calculation unit 43 to the processing device 108 and receives signals output from the central processing device 108.

Each of the resistors 45 has the same resistance value.

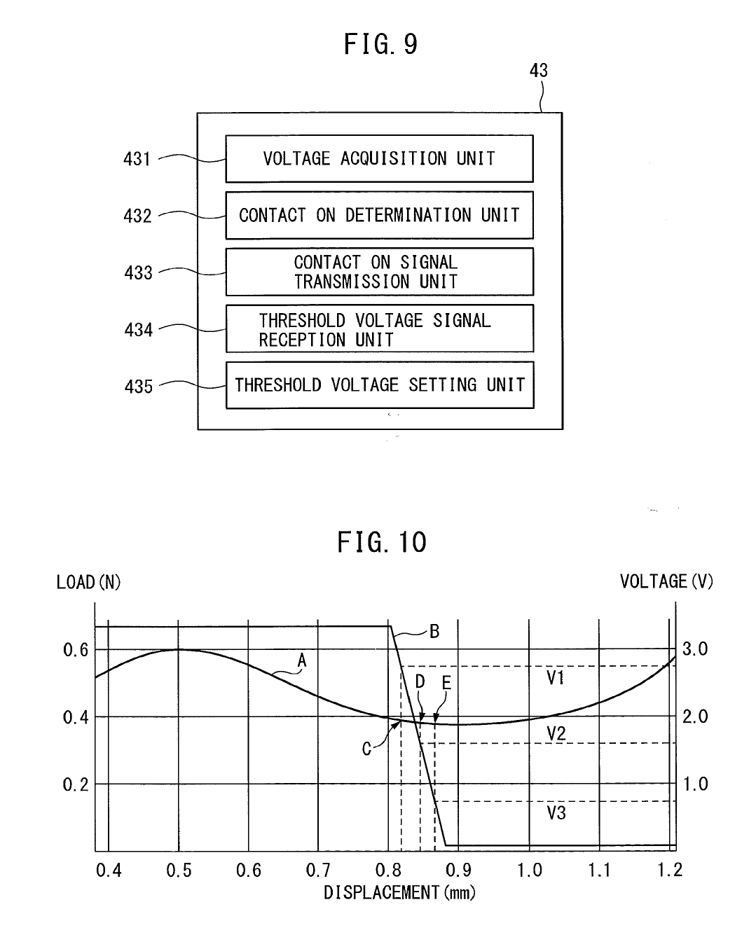

FIG. 9 is a block diagram of functions of the calculation unit 43.

The calculation unit 43 has an acquisition unit 431, a determination unit 432, a transmission unit 433, a reception unit 434, and a setting unit 435.

The acquisition unit 431 acquires the contact voltage of each of the first contacts 34 and the corresponding key switch number from the key I/O unit 41 in a predetermined period.

The determination unit 432 compares the contact voltage acquired by the acquisition unit and the threshold voltage stored in the storage unit 42. When comparing the acquired contact voltage and the threshold voltage, the determination unit 432 associates the key switch number acquired from the key I/O unit and the key switch number stored in the storage unit 42 with each other. When the determination unit 432 determines that the contact voltage is smaller than the threshold voltage, the determination unit 432 determines that the key switch is in the on state.

When the determination unit 432 determines that the switch is in the on state, the transmission unit 433 transmits an on signal indicating the on state of the switch. The on signal transmitted from the transmission unit 433 is transmitted to the processing device 108 via the calculation device I/O unit 44.

When setting or changing the threshold voltage of the key switch, the reception unit 434 receives a threshold voltage signal indicative of the threshold voltage to be set and a key switch number signal specifying the key switch from the processing device 108 via the calculation device I/O unit 44. When the reception unit 434 receives the threshold voltage signal and the key switch number, the setting unit 435 changes the threshold voltage stored in the storage unit 42 corresponds to the received key switch number to a voltage corresponding to the received threshold voltage signal. When changing the threshold voltage stored in the storage unit 42, the setting unit 435 changes the threshold voltage corresponding to the key switch number by associating the key switch number received from the processing device 108 and the key switch number stored in the storage unit 42, and stores the threshold value into the storage unit 42.

FIG. 10 is a graph showing a relationship between the threshold voltage and the displacement of the key top 21 in the vertical direction. In FIG. 10, the horizontal axis represents the displacement of the key top 21, the vertical axis on the left side represents the press-down load, and the vertical axis on the right side represents the contact voltage. The graph indicated by A shows a relationship between the displacement of the key top 21 and the press-down load when the key switch device 2 is pressed down. The graph indicated by B shows a relationship between the displacement of the key top 21 and the contact voltage between the first contact 34 and the second contact 35.

In FIG. 10, a first threshold voltage V1 is 2.8 V, a second threshold voltage V2 is 1.6 V, and a third threshold voltage V3 is 0.8 V.

When the setting unit 435 sets the threshold voltage to the first threshold voltage V1, the displacement of the key top 21 which brings the key switch device 2 into the on state is 0.83 mm. When the setting unit 435 sets the threshold voltage to the second threshold voltage V2, the displacement of the key top 21 which brings the key switch device 2 into the on state is 0.85 mm. When the setting unit 435 sets the threshold voltage to the third threshold voltage V3, the displacement of the key top 21 which brings the key switch device 2 into the on state is 0.87 mm. Loads indicated by arrows C to E are press-down loads when the setting unit 435 sets the threshold voltage to the first threshold voltage V1, to the second threshold voltage V2, and to the third threshold voltage V3, respectively. As the threshold voltage is reduced, the press-down load is reduced accordingly.

By changing the threshold voltage, the displacement of the key top 21 and the magnitude of the press-down load necessary to bring the key switch device 2 into the on state change. By setting the threshold voltage so that the key switch device 2 enters the on state with the displacement and the press-down load preferred by a user of the keyboard 1, it is possible to provide a feeling of typing desired by a user.

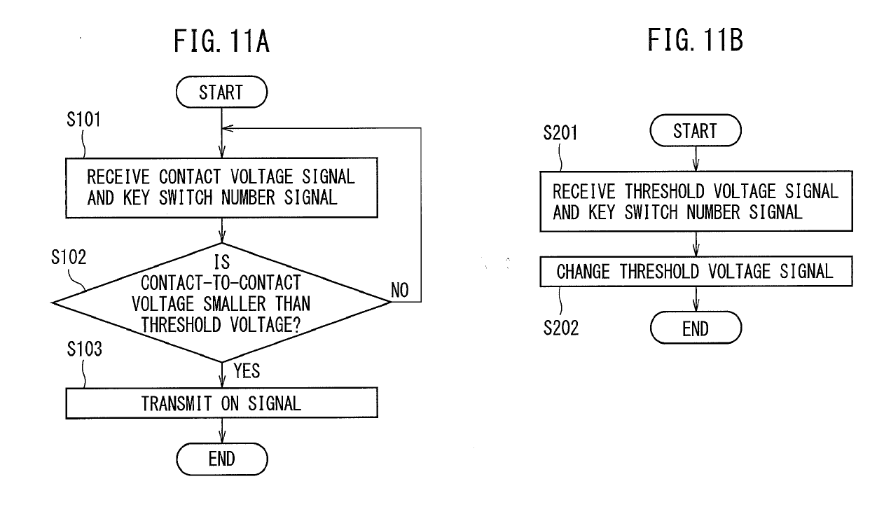

FIG. 11A is a flowchart illustrating a determination processing of the calculation unit 43, and FIG. 11B is a flowchart illustrating a threshold value setting processing of the calculation unit 43.

When the on state of the switch is determined, the acquisition unit 431 acquires the voltage signal and the key switch number signal of the corresponding key switch device 2 from the key I/O unit 41 at S101.

At S102, the determination unit 432 compares the contact voltage corresponding to the voltage signal acquired by the acquisition unit and the threshold voltage of the key switch stored in the storage unit 42. When the determination unit 432 determines that the contact voltage is greater than the threshold voltage, the processing returns to S101 and the processing at S101 and S102 is repeated in each predetermined period of time.

When the determination unit 432 determines that the contact voltage is smaller than the threshold voltage at S102, the determination unit 432 determines that the contact is turned on and the processing proceeds to S103. Then, at S103, the transmission unit 433 transmits an on signal to the processing device 108.

When setting the threshold value of the key switch, the reception unit 434 receives the threshold voltage signal and the key switch number signal from the processing device 108 at S201 in FIG. 11B. Then, at S202, the setting unit 435 changes the threshold voltage stored in the storage unit 42 to the voltage corresponding to the received threshold voltage signal. The changed threshold voltage is associated with the received key switch number and stored in the storage unit 42.

The setting of the threshold voltage can be performed by an operator of the personal computer 100 via the screen displayed on the LCD panel module 105. The computer program to set the threshold voltage and the computer program to display the graphical user interface for setting the threshold voltage are stored in a main storage device connected to the processing device 108.

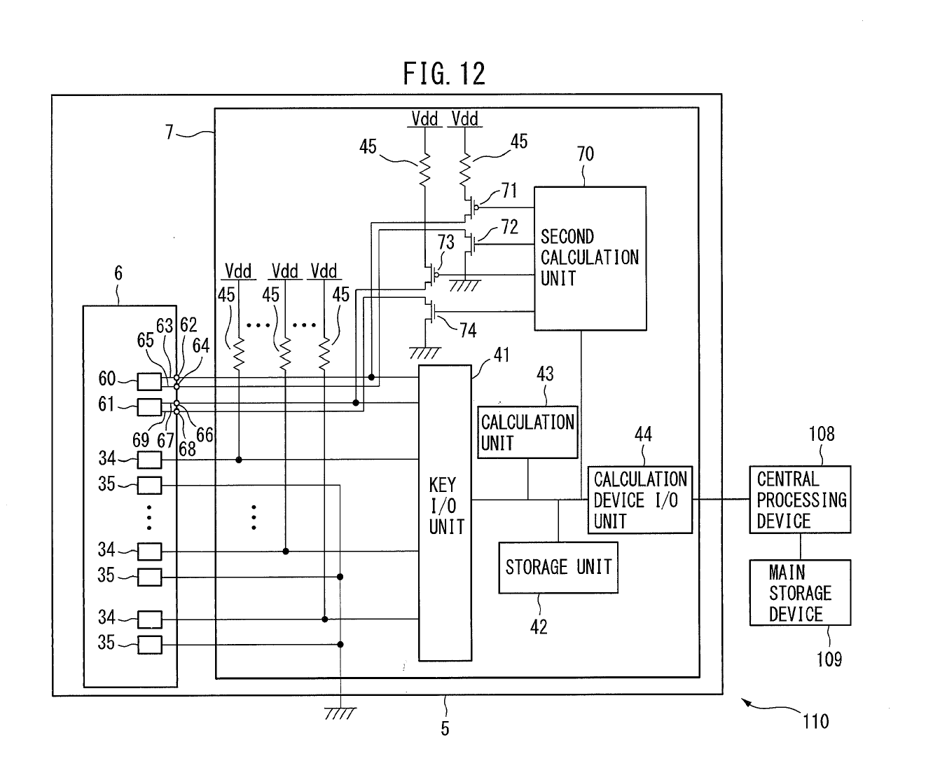

FIG. 12 is a circuit block diagram of another example of the personal computer.

The personal computer 110 includes a keyboard 5. The keyboard 5 includes a membrane sheet 6 and a control device 7.

The membrane sheet 6 includes a first contact 60 and a second contact 61 in addition to the first contacts 34 and second contacts 35.

The membrane sheet 6 has a first terminal 62, a second terminal 64, a third terminal 66 and a fourth terminal 68. The first contact 60 is connected to the first terminal 62 via a first wire 63 and to the second terminal 64 via a second wire 65, respectively. The second contact 61 is connected to the third terminal 66 via a third wire 67 and to the fourth terminal 68 via a fourth wire 69, respectively.

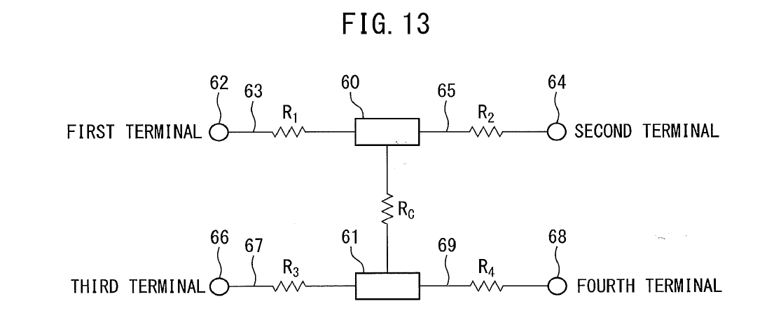

FIG. 13 is an equivalent circuit diagram illustrating a connection relationship between the first contact 60 and the second contact 61 and the first terminal 62 to the fourth terminal 68.

The resistance value of the wire resistance of the first wire 63 that connects the first contact 60 and the first terminal 62 is taken to be R₁, and the resistance value of the wire resistance of the second wire 65 that connects the first contact 60 and the second terminal 64 is taken to be R₂. The resistance value of the wire resistance of the third wire 67 that connects the second contact 61 and the third terminal 66 is taken to be R₃, and the resistance value of the wire resistance of the fourth wire 69 that connects the second contact 61 and the fourth terminal 68 is taken to be R₄. Further, the resistance value of the contact resistance between first contact 60 and the second contact 61 is taken to be R_{c}.

The resistance value of the wire resistance between the first terminal 62 and the fourth terminal 68 is expressed by (R₁+R_{c}+R₄), and the resistance value of the wire resistance between the second terminal 64 and the third terminal 66 is expressed by (R₂+R_{c}+R₃). Further, the resistance value of the wire resistance between the first terminal 62 and the second terminal 64 is expressed by (R₁+R₂), and the resistance value of the wire resistance between the third terminal 66 and the fourth terminal 68 is expressed by (R₃+R₄).

Consequently, the contact resistance R_{c} between the first contact 60 and the second contact 61 can be calculated from the resistance values of the wire resistances between the terminals as expressed by expression (1).

$${R}_{c} = \frac{( {R}_{1} + {R}_{c} + {R}_{4} ) + ( {R}_{2} + {R}_{c} + {R}_{3} ) - ( {R}_{1} + {R}_{2} ) - ( {R}_{3} + {R}_{4} )}{2} \qquad ( 1 )$$

The control device 7 has a second calculation unit 70. Further, the control device 7 has a first switch 71, a second switch 72, a third switch 73 and a fourth switch 74.

The first switch 71 and the third switch 73 are each a pMOS transistor the source of which is connected to a power source voltage Vdd. The drain of the first switch 71 is connected to the first terminal 62, and the drain of the third switch 73 is connected to the third terminal 66. The second switch 72 and the fourth switch 74 are each an nMOS transistor the source of which is grounded. The drain of the second switch 72 is connected to the second terminal 64, and the drain of the fourth switch 74 is connected to the fourth terminal 68. The gates of the first switch 71, the second switch 72, the third switch 73 and the fourth switch 74 are connected to the second calculation unit 70.

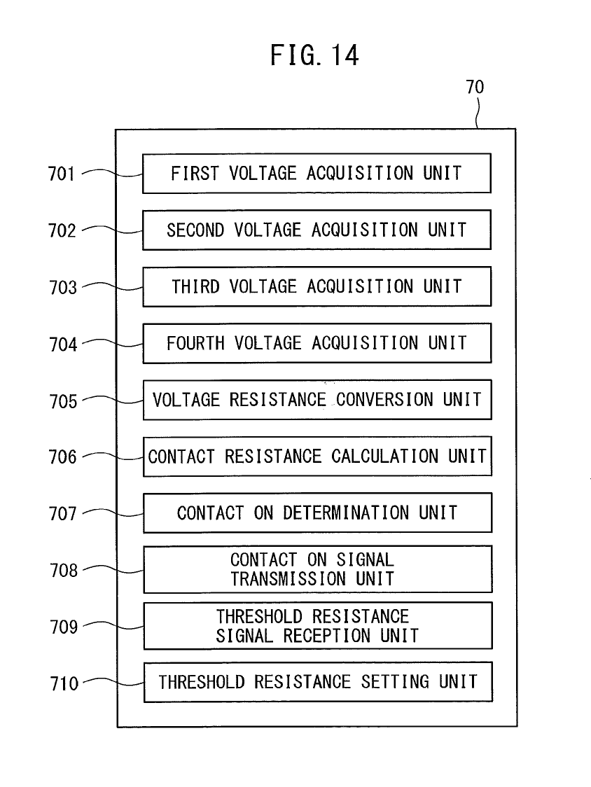

FIG. 14 is a block diagram of the second calculation unit 70.

The second calculation unit 70 has a first acquisition unit 701, a second acquisition unit 702, a third acquisition unit 703, a fourth acquisition unit 704, a conversion unit 705 and a calculation unit 706. The second calculation unit 70 further has a determination unit 707, a transmission unit 708, a reception unit 709 and a setting unit 710.

The first acquisition unit 701 turns on the first switch 71 to connect the first terminal 62 and the resistor 45 and turns on the fourth switch 74 to ground the fourth terminal 68 and thus acquires a first voltage indicative of the terminal voltage between the first terminal 62 and the fourth terminal 68. After acquiring the first voltage, the first acquisition unit 701 turns off the first switch 71 and the fourth switch 74.

The second acquisition unit 702 turns on the third switch 73 to connect the third terminal 66 and the resistor 45 and turns on the second switch 72 to ground the second terminal 64 and thus acquires a second voltage indicative of the terminal voltage between the second terminal 64 and the third terminal 66. After acquiring the second voltage, the second acquisition unit 702 turns off the second switch 72 and the third switch 73.

The third acquisition unit 703 turns on the first switch 71 to connect the first terminal 62 and the resistor 45 and turns on the second switch 72 to ground the second terminal 64 and thus acquires a third voltage indicative of the terminal voltage between the first terminal 62 and the second terminal 64. After acquiring the third voltage, the third acquisition unit 703 turns off the first switch 71 and the second switch 72.

The fourth acquisition unit 704 turns on the third switch 73 to connect the third terminal 66 and the resistor 45 and turns on the fourth switch 74 to ground the second terminal 68 and thus acquires a fourth voltage indicative of the terminal voltage between the third terminal 66 and the fourth terminal 68. After acquiring the fourth voltage, the fourth acquisition unit 704 turns off the third switch 73 and the fourth switch 74.

The conversion unit 705 converts the acquired first to fourth voltages into first to fourth resistance values, respectively. The conversion unit 705 converts the first to fourth voltages into the first to fourth resistance values, respectively, by referring to a voltage resistance conversion table stored in the storage unit 42. The first resistance value corresponds to the resistance value (R₁+R_{c}+R₄) of the wire resistance between the first terminal 62 and the fourth terminal 68, and the second resistance value corresponds to the resistance value (R₂+R_{c}+R₃) of the wire resistance between the second terminal 64, and the third terminal 66. The third resistance value corresponds to the resistance value (R₁+R₂) of the wire resistance between the first terminal 62 and the second terminal 64 and the fourth resistance value corresponds to the resistance value (R₃+R₄) of the wire resistance between the third terminal 66 and the fourth terminal 68.

The calculation unit 706 calculates the resistance value R_{c} of the contact resistance by performing a calculation in accordance with the expression (1) using the first to fourth resistance values converted by the conversion unit 705.

The determination unit 707 compares the resistance value R_{c} of the contact resistance calculated by the calculation unit 706 and the threshold resistance value stored in the storage unit 42 for determining whether or not the key switch device 2 is in the on state. When it determines that the resistance value R_{c} is smaller than the threshold resistance value, the determination unit 707 determines that the switch is in the on state.

When the determination unit 707 determines that the switch is in the on state, the transmission unit 708 transmits the on signal. The on signal transmitted from the transmission unit 708 is transmitted to the processing device 108 via the calculation device I/O unit 44.

When setting or changing the threshold resistance value, the reception unit 709 receives the threshold resistance value from the processing device 108 via the calculation device I/O unit 44. When the threshold resistance value is received, the reception unit 709 changes the threshold resistance value stored in the storage unit 42 to the received threshold resistance value.

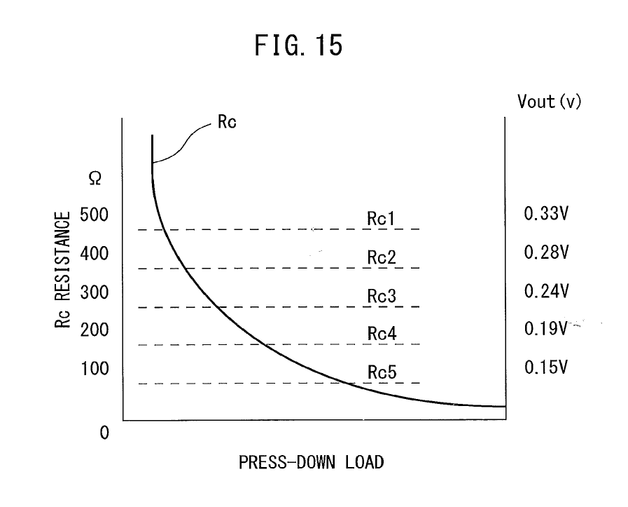

FIG. 15 is a graph showing an example of a relationship between the threshold resistance value and the operation load. FIG. 15 illustrates the case where the resistance value of the resistor 45 is 10 kΩ and the resistance values R₁ to R₄ are each 100Ω. In FIG. 15, the horizontal axis represents the press-down load and the vertical axis represents the contact resistance R_{c} between the first contact 60 and the second contact 61, and R_{cl} to R_{c5} are each a threshold resistance value to be set.

The contact resistance R_{c} between the first contact 60 and the second contact 61 decreases as the press-down load increases, i.e. as the displacement of the key top increases. The threshold resistance value R_{c1} is larger than the threshold resistance value R_{c2}, the threshold resistance value R_{c2} is larger than the threshold resistance value R_{c3}, the threshold resistance value R_{c3} is larger than the threshold resistance value R_{c4}, and the threshold resistance value R_{c4} is larger than the threshold resistance value R_{c5}. The contact voltages corresponds to the threshold resistance values R_{cl} to R_{c5} are 0.33 V, 0.28V, 0.24V, 0.19V and 0.15 V, respectively. From the relationship shown in FIG. 15, it is possible to derive the contact resistance from the contact voltage and to convert the detected contact voltage into the contact resistance value to compare with the set threshold value.

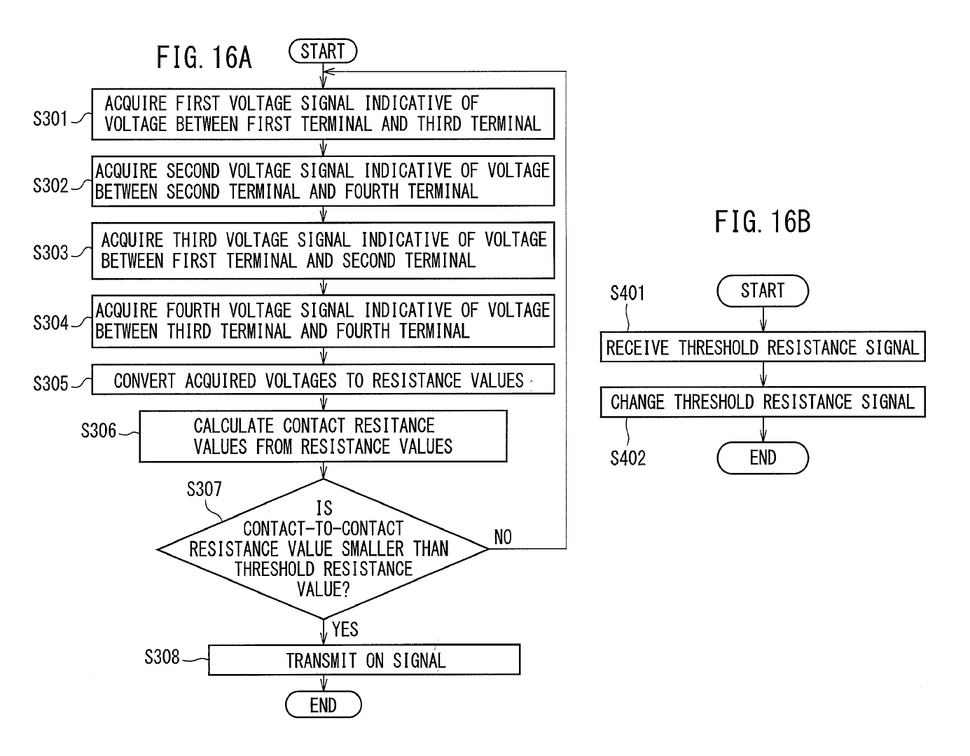

FIG. 16A is a flowchart illustrating a determination processing of the second calculation unit 70 and FIG. 16B is a flowchart illustrating threshold value setting processing of the second calculation unit 70.

When determining whether or not the contact turns on, the first acquisition unit 701 turns on the first switch 71 to connect the first terminal 62 and the resistor 45 and turns on the fourth switch 74 to ground the fourth terminal 68 at step S301. The first acquisition unit 701 acquires a first voltage signal indicative of the voltage between the first terminal 62 and the fourth terminal 68.

Next, at step S302, the second acquisition unit 702 turns on the third switch 73 to connect the third terminal 66 and the resistor 45 and turns on the second switch 72 to ground the second terminal 64. The second acquisition unit 702 acquires a second voltage signal indicative of the voltage between the second terminal 64 and the third terminal 66.

Next, at step S303, the third acquisition unit 703 turns on the first switch 71 to connect the first terminal 62 and the resistor 45 and turns on the second switch 72 to ground the second terminal 64. The third acquisition unit 703 acquires a third voltage signal indicative of the voltage between the first terminal 62 and the second terminal 64.

Next, at step S304, the fourth acquisition unit 704 turns on the third switch 73 to connect the third terminal 66 and the resistor 45 and turns on the fourth switch 74 to ground the fourth terminal 68. The fourth acquisition unit 704 acquires a fourth voltage signal indicative of the voltage between the third terminal 66 and the fourth terminal 68.

Next, at S305, the conversion unit 705 converts the acquired first to fourth voltages into the first to fourth resistance values, respectively.

Next, at S306, the calculation unit 706 calculates the resistance value R_{c} of the contact resistance from the first to fourth resistance values converted by the conversion unit 705.

Next, at S307, the determination unit 707 compares the resistance value R_{c} of the contact resistance calculated by the calculation unit 706 and the threshold resistance value. When the determination unit 707 determines that the resistance value R_{c} is larger than the threshold resistance value, the processing returns to S301 and the processing from S301 is performed in each predetermined period of time.

When the determination unit 707 determines that the resistance value R_{c} is smaller than the threshold resistance value at S307, determination unit 707 determines that the contact is turned on and the processing proceeds to S308. At S308, the transmission unit 708 transmits the on signal to the processing device 108

When threshold resistance value is set or changed, the reception unit 709 receives the threshold resistance value from the processing device 108 at S401. Then, at S402, the setting unit 710 changes the threshold resistance value stored in the storage unit 42 so as to correspond to the received threshold resistance value.

According to the keyboard explained hitherto, it is possible to change a feeling of typing for each key switch device without changing the structure of the keyboard. In the explained keyboard, it is possible to set or change the conditions under which the key switch device enters the on state in accordance with the contact voltage between the contacts of the key switch device or the resistance value of the contact resistance. In other words, in the explained keyboard, it is possible to set the conditions under which the key switch device enters the on state in accordance with the displacement of the key top of the key switch device, and therefore it is possible to set the conditions under which the key switch device enters the on state so that the feeling of typing differs for each key switch device. Further, in the explained keyboard, it is possible to change the threshold value for determining whether or not the key switch device is in the on state, and therefore it is possible to set the feeling of typing of the key switch device for each key switch device in accordance with an operator's preference. According to the keyboard explained, it is not necessary to change the structure of the key switch device.

Further, in the keyboard according to embodiments, it is possible to set the conditions under which the key switch device enters the on state in accordance with the resistance value of the contact resistance between the contacts of the key switch device. In the keyboard according to embodiments, it is possible to eliminate the influence of the resistance of the wire between the contact arranged on the membrane sheet and the control device, and therefore it is possible to more accurately set the conditions under which the key switch device enters the on state.

The keyboard of the embodiment uses the contact voltage or the resistance value of the contact resistance. However, it is possible to set the conditions under which the key switch device enters the on state based on another element indicative of the contact state between the contacts, such as a current between the contacts.

In the keyboard of the embodiments, one control device controls the on state of key switch devices. However, it is possible to arrange a control device for each key switch device. Further, it is possible to control the on state of all the key switch devices arranged on the keyboard or to control the on state of the single or several key switch devices of the key switch devices arranged on the keyboard. For example, it is possible to set the conditions under which the key switch device enters the on state based on the frequency of each key switch device used, that the key switch device used in high frequency enters the on state with less displacement of the key top compared to that of the other key switch devices. Further, it is possible to set the conditions under which the key switch device enters the on state so that the key switch device used as an important key, such as a determination key, enters the on state with more displacement compared to that of the other key switch devices.

Furthermore, it is possible to set the conditions so that the key switch device used as an important key such as a determination key enters the on state when other necessary conditions are satisfied, in addition to the contact state between the contacts. For example, it is possible to set the conditions so that the key switch device enters the on state when the time during which the resistance value of the contact resistance between the contacts is smaller than the threshold resistance value becomes longer than a predetermined threshold time. The calculation unit starts measurement of time when the resistance value of the contact resistance between the contacts becomes smaller than the threshold resistance value, and determines whether or not the state where the resistance value of the contact resistance between the contacts is smaller than the threshold resistance value lasts for a predetermined threshold time. When determining that the state where the resistance value of the contact resistance between the contacts is smaller than the threshold resistance value lasts for a predetermined threshold time, the calculation unit transmits the on state signal. When the resistance value of the contact resistance between the contacts becomes larger than the threshold resistance value before a predetermined threshold time elapses, the calculation unit determines that the state is not the on state and stops measurement of time.

Further, in the explained keyboard, the membrane sheet is used as a switch. However, it is possible to use a mechanical switch with a spring which is a conductor in the shape of a dome as the switch. In the case of the mechanical switch, when the key top is pressed down, the spring bends and brings the contact located under the spring into the on state.

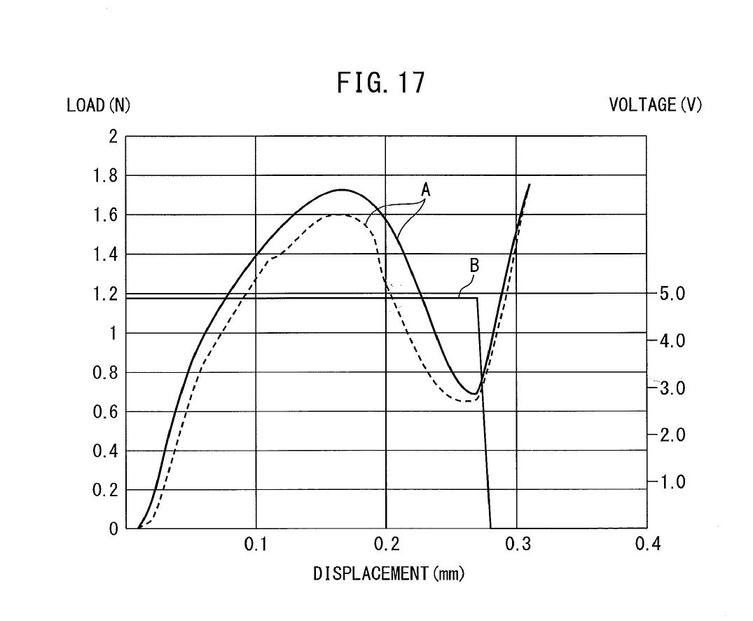

FIG. 17 is a graph showing a relationship between the press-down load of the key switch device having the mechanical switch, the contact voltage, and the displacement of the key top in the vertical direction. In FIG. 17, the horizontal axis represents the displacement of the key top, the vertical axis on left side represents the press-down load, and the vertical axis on the right side represents the contact voltage between the contacts located under a spring. The graph indicated by A shows a relationship between the displacement of the key top and the press-down load when the key switch device is pressed down. The graph indicated by B shows a relationship between the displacement of the key top and the contact voltage between the contacts located under the spring. In FIG. 17, the solid line indicates a relationship between the press-down load and the displacement of the mechanical switch when displacement of the key top increases and the broken line indicates a relationship between the press-down load and the displacement of the mechanical switch when displacement of the key top decreases.

As illustrated in FIG. 17, even if the key switch device having a mechanical switch is used, as in the case of the keyboards using the membrane sheet, it is possible to set the conditions under which the key switch device enters the on state in accordance with the resistance value of the contact resistance between the contacts of the key switch device.

Further, in the keyboard 5, the voltage resistance conversion unit 705 converts the first voltage to the fourth voltage into the first resistance value to the fourth resistance value, respectively, by referring to the voltage resistance conversion table stored in the storage unit 24. However, it is possible to convert the voltage into the resistance value by calculation. For example, in the case where the resistance value of the dummy resistor 45 is already known, it is possible to convert the first voltage to the fourth voltage into the first resistance value to the fourth resistance value, respectively, by performing calculations based on expressions (2) to (5) using the power source voltage Vdd and a resistance value R_{D} of the dummy resistor.

$$\begin{matrix}\frac{{V}_{dd}}{( {R}_{1} + {R}_{c} + {R}_{4} ) + {R}_{d}} = \frac{{V}_{1 - 4}}{{R}_{1} + {R}_{c} + {R}_{4}} \\ ∴ {R}_{1} + {R}_{c} + {R}_{4} = \frac{{R}_{d}}{{V}_{dd}} \cdot {V}_{1 - 4} & ( 2 ) \\ \frac{{V}_{dd}}{( {R}_{2} + {R}_{c} + {R}_{3} ) + {R}_{d}} = \frac{{V}_{2 - 3}}{{R}_{2} + {R}_{c} + {R}_{3}} \\ ∴ {R}_{2} + {R}_{c} + {R}_{3} = \frac{{R}_{d}}{{V}_{dd}} \cdot {V}_{2 - 3} & ( 3 ) \\ \frac{{V}_{dd}}{( {R}_{1} + {R}_{2} ) + {R}_{d}} = \frac{{V}_{1 - 2}}{{R}_{1} + {R}_{2}} \\ ∴ {R}_{1} + {R}_{2} = \frac{{R}_{d}}{{V}_{dd}} \cdot {V}_{1 - 2} & ( 4 ) \\ \frac{{V}_{dd}}{( {R}_{3} + {R}_{4} ) + {R}_{d}} = \frac{{V}_{3 - 4}}{{R}_{3} + {R}_{4}} \\ ∴ {R}_{3} + {R}_{4} = \frac{{R}_{d}}{{V}_{dd}} \cdot {V}_{3 - 4} & ( 5 )\end{matrix}$$

What is claimed is:

1. A key switch device comprising:
a key top;
a switch having a first contact and a second contact and in which a contact state between the first contact and the second contact changes in accordance with a movement distance of the pressed key top; and
a control device configured to acquire a signal indicative of the contact state between the first contact and the second contact, determine whether or not the switch is in the on state by comparing a contact state value corresponding to the acquired signal and a threshold value that is arbitrarily set, and transmit an on signal indicating the on state when determining that the switch is in the on state.

2. The key switch device according to claim 1, wherein
the signal indicates a voltage between the first contact and the second contact, and
the control device determines that the switch is in the on state when the signal is smaller than the threshold voltage.

3. The key switch device according to claim 1, wherein
the contact state signal indicates a value of a contact resistance between the first contact and the second contact, and
the threshold value indicates a threshold resistance value.

4. The key switch device according to claim 3, wherein
the switch further has a first terminal and a second terminal connected to the first contact and a third terminal and a fourth terminal connected to the second contact, and
the control device calculates the resistance value of the contact resistance based on a first resistance value between the first terminal and the fourth terminal, a second resistance value between the second terminal and the third terminal, a third resistance value between the first terminal and the second terminal, and a fourth resistance value between the third terminal and the fourth terminal.

5. A keyboard comprising:
key switches, each of the key switches includes:
a key top; and
a switch having a first contact and a second contact, a contact state between the first contact and the second contact changes in accordance with a movement distance of the pressed key top;
a controller that determines whether each of the switches is in the on state or not by comparing a signal indicative of the contact state between the first contact and the second contact and a threshold value that is arbitrarily set; and
a storage for storing the set threshold value.

6. The keyboard according to claim 6, wherein the storage stores the threshold value of a certain key switch with information identifying the key switch.
